(19) United States
(12) Patent Application Publication
(10) Pub. No.: US 2016/0008676 A1
(43) Pub. Date: Jan. 14, 2016

(54) GOLF CLUB HEAD, GOLF CLUB, GOLF CLUB PERFORMANCE EVALUATION METHOD, AND GOLF CLUB AND GOLF BALL SET

(71) Applicants: BRIDGESTONE CORPORATION, Tokyo (JP); BRIDGESTONE SPORTS CO., LTD, Tokyo (JP)

(72) Inventors: Kazuo UCHIDA, Fuchu-shi (JP); Atsushi KOMATSU, Chichibu-shi (JP); Wataru BAN, Chichibu-shi (JP)

(73) Assignees: BRIDGESTONE SPORTS CO., LTD, Tokyo (JP); BRIDGESTONE CORPORATION, Tokyo (JP)

(21) Appl. No.: 14/791,925

(22) Filed: Jul. 6, 2015

(30) Foreign Application Priority Data
Jul. 11, 2014 (JP) 2014-143699
Dec. 19, 2014 (JP) 2014-257457

(51) Int. Cl. A63B 53/04; G01N 19/02

(52) U.S. Cl. CPC A63B 53/04; G01N 19/02

(57) ABSTRACT

It could be helpful to provide a golf club head, a golf club and a set of golf club and golf ball that can reliably reduce an amount of backspin of a golf ball; and a golf club performance evaluation method that can determine the amount of backspin imparted on a golf ball.

A golf club head having a face on which a slip quantity of a golf ball when the golf ball and the face collide with each other is 0.55 mm or less is provided.

### TECHNICAL FIELD

This disclosure relates to a golf club head, a golf club, a golf club performance evaluation method, and a golf club and golf ball set.

### BACKGROUND

Golfers have a constant desire to hit long and accurate shots. In developing higher performance golf balls or golf clubs to meet this desire, it is very important to study a contact phenomenon between a golf ball and a golf club.

It has been conventionally known that the amount of spin of a golf ball significantly affects carry performance.

With a wood-type golf club head, for example, a large amount of backspin does not lead to an increase in carry. In such a case, the carry can be increased by reducing the amount of backspin.

To estimate the amount of spin of a golf ball, for example, Patent Literature (PTL) 1 describes the following method of measuring the coefficient of kinetic friction of a golf ball and a impact plate tilted at a predetermined angle with respect to the flight direction of the golf ball when the golf ball impacts with the impact plate: The time function of the contact force in the direction perpendicular to the impact plate and the time function of the contact force in the direction parallel to the impact plate are simultaneously determined, and the coefficient of kinetic friction is calculated based on a specific relational expression.

Moreover, techniques of regulating the coefficient of friction of the face of a golf club head and a golf ball in order to control the amount of spin of the golf ball have been developed in recent years.

For example, PTL 2 describes a technique of reducing the amount of spin of a golf ball by forming the face as a high-friction surface whose high-load friction coefficient μ, which is the maximum static friction coefficient when a high load of 400 kgf acts between the face and the ball, is 0.35 or more and 0.6 or less.

### CITATION LIST

### Patent Literature

PTL 1: JP 2006-343139 A

PTL 2: JP 3475083 B

### SUMMARY

With the technique in PTL 2, however, the amount of spin cannot be controlled efficiently.

It could be helpful to provide a golf club head, a golf club, and a golf club and golf ball set that can reduce the amount of backspin of a golf ball, and a golf club performance evaluation method that can determine the amount of backspin imparted on a golf ball.

As a result of conducting study to solve the problem of the amount of spin, we have discovered that the most important factor for a reaction force of torsional deformation (hereafter referred to as “torsional reaction force” according to need) of the golf ball is a slip quantity of the golf ball on the face of the golf club head, and the amount of spin can be reliably regulated by controlling the slip quantity of the golf ball.

We thus provide the following.

The disclosed golf club head has a face on which a slip quantity of a golf ball when the golf ball and the face collide with each other is 0.55 mm or less. The amount of backspin of the golf ball can thus be reduced.

The slip quantity of the golf ball is preferably 0.50 mm or less.

A contact time between the golf ball and the face is preferably 0.4 msec to 0.7 msec.

The golf club head preferably has a loft of 20° or less.

The disclosed golf club includes the golf club head described above.

The disclosed golf club performance evaluation method includes: measuring a slip quantity of a golf ball when the golf ball and a face of a golf club head collide with each other, and providing an evaluation. The amount of backspin imparted on the golf ball by the golf club can thus be determined.

The evaluation preferably includes an index of whether or not the slip quantity of the golf ball is 0.55 mm or less. This enables evaluation of whether or not the amount of backspin of the golf ball can be reliably reduced.

The disclosed golf club and golf ball set has a feature that a slip quantity of a golf ball on a face of a golf club head when the golf ball and the golf club head collide with each other is 0.55 mm or less. The amount of backspin of the golf ball can thus be reliably reduced.

It is thus possible to provide a golf club head, a golf club, and a golf club and golf ball set that can reduce the amount of backspin of a golf ball, and a golf club performance evaluation method that can determine the amount of backspin imparted on a golf ball.

### BRIEF DESCRIPTION OF THE DRAWINGS

In the accompanying drawings:

FIGS. 1A to 1D show a flow diagram schematically illustrating the flow from when a golf club head and a golf ball collide with each other to when the golf ball has backspin;

FIGS. 2A to 2D show a flow diagram schematically illustrating the flow from when a conventional golf club head and a golf ball collide with each other to when the golf ball has backspin;

FIGS. 3A to 3D show a flow diagram schematically illustrating the flow from when a golf club head according to one of the disclosed embodiments and a golf ball collide with each other to when the golf ball has backspin;

FIG. 4 shows a diagram schematically illustrating an example of the disclosed method of measuring the slip quantity of a golf ball;

FIG. 5 shows a diagram schematically illustrating another example of the disclosed method of measuring the slip quantity of a golf ball;

FIG. 6A shows a photograph of the collision state between a golf club head and a golf ball in each sample in Example 1 recorded from the front, and FIG. 6B shows a photograph of the collision state between a golf ball and a impact plate in each sample in Example 1 recorded from the side; and

FIG. 7A shows a diagram illustrating the temporal changes of the slip quantity (mm) of a golf ball in each sample in Example 1, and FIG. 7B shows a diagram illustrating the temporal changes of the rotation angle (rad) of a golf ball in each sample in Example 1.

### DETAILED DESCRIPTION

One of the disclosed embodiments is described in detail below.

(Golf Club Head)

The disclosed golf club head has a face on which the slip quantity of a golf ball when the golf ball and the face collide with each other is 0.55 mm or less. This golf club head may be, for example, made of a metal material. Examples of the metal material include titanium, a titanium alloy, stainless steel, and an aluminum alloy.

By limiting the slip quantity of the golf ball to a low value of 0.55 mm or less, the amount of backspin can be reduced.

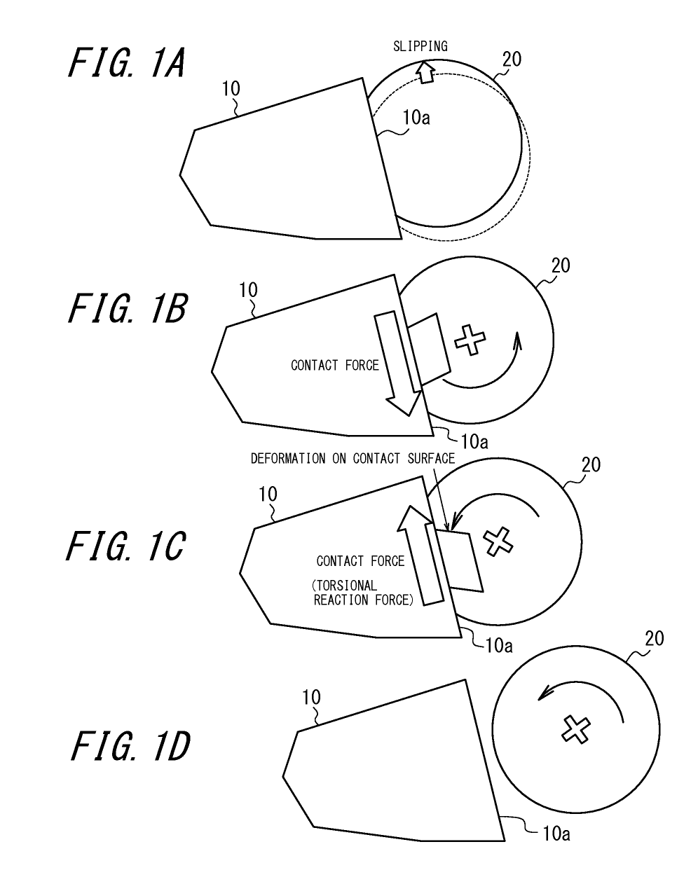

FIGS. 1A to 1D show a schematic flow diagram illustrating the flow from when a golf club head and a golf ball collide with each other to when the golf ball has backspin, where the collision state is viewed from the side.

When a face 10a of a golf club head 10 and a golf ball 20 collide with each other, the golf ball 20 slips upward (the direction of the arrow) on the face 10a (FIG. 1A). The golf ball 20 then rotates. This rotation force stops the above-mentioned slip, and causes the golf ball 20 to rotate in the backspin direction (FIG. 1B). When the amount of rotation in the backspin direction increases, a torsional reaction occurs in the golf ball 20, which generates a force (torsional reaction force) in the direction opposite to the backspin direction (FIG. 1C). The torsional reaction force reduces the amount of rotation in the backspin direction (FIG. 1D).

Since the torsional reaction force occurs after the golf ball 20 stops slipping, a high torsional reaction force is obtained by reducing the slip quantity of the golf ball to 0.55 mm or less, as a result of which the amount of spin can be reduced. The slip quantity of the golf ball is preferably 0.50 mm or less, and more preferably 0.35 mm or less, to further reduce the amount of spin.

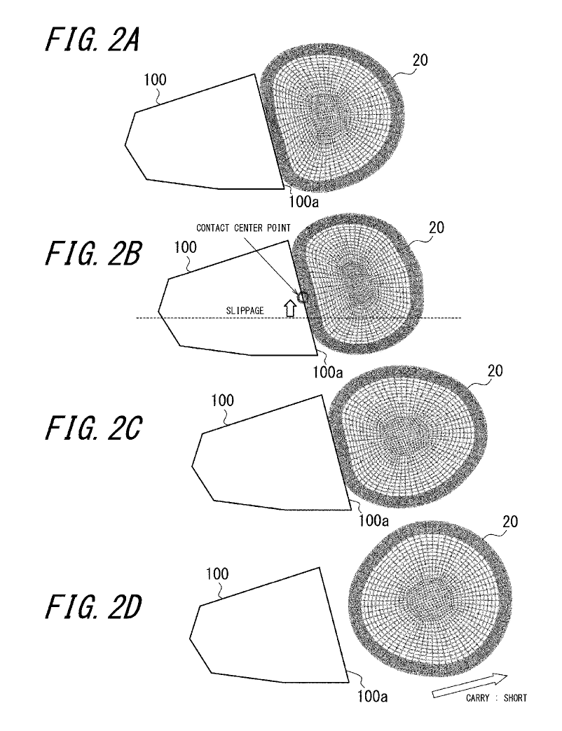

Consider the case of hitting a golf ball using a conventional golf club head. As illustrated in FIGS. 2A to 2D, after the golf ball 20 and a face 100a of a golf club head 100 collide with each other (FIG. 2A), the contact center point (indicated by the white circle in FIG. 2B) of the golf ball 20 moves upward from the point immediately after the contact (indicated by the dotted line in FIG. 2B). In detail, the golf ball 20 slips upward to a large extent (FIG. 2B), and then a torsional reaction occurs in the golf ball 20, which generates a torsional reaction force in the direction opposite to the backspin direction (FIG. 2C). However, this torsional reaction force is not large, and does not contribute to sufficient carry performance (FIG. 2D).

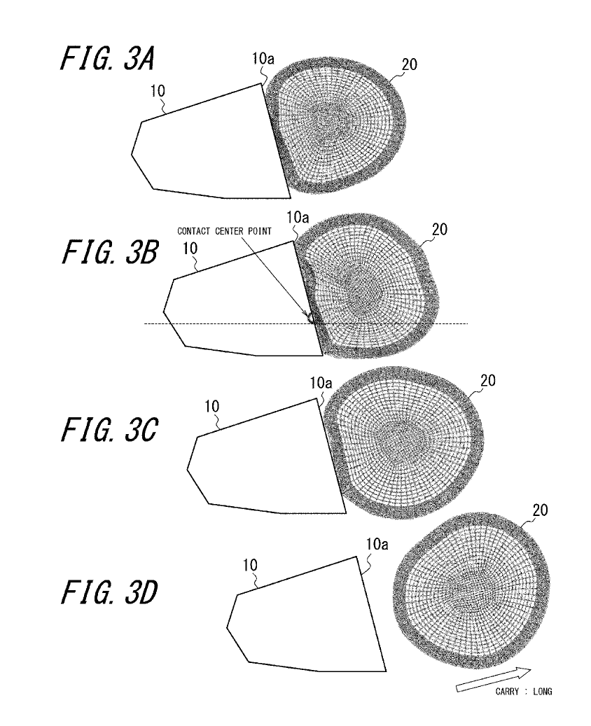

Consider the case of hitting a golf ball using the disclosed golf club head. As illustrated in FIGS. 3A to 3D, after the golf ball 20 and the face 10a of the golf club head 10 collide with each other (FIG. 3A), the contact center point (indicated by the white circle in FIG. 3B) of the golf ball 20 hardly moves from the point immediately after the contact (indicated by the dotted line in FIG. 3B). Since there is little slip (FIG. 3B), the torsional reaction force is large (FIG. 3C) as compared with the case of using the conventional golf club head. This reduces the amount of rotation in the backspin direction, and provides better carry performance (FIG. 3D).

The slip quantity of the golf ball in this disclosure means the distance traveled by the contact center point of the golf ball on the contact surface from when the golf ball and the face of the golf club head come into contact with each other to when the golf ball and the face of the golf club head separate from each other.

For example, the slip quantity can be obtained by observing, from the face and/or the side, the contact state between the face of the golf club head and the golf ball and measuring how far the point marked on the golf ball has moved in the vertical direction of the golf club.

The golf ball used to measure the slip quantity is not particularly limited, and various golf balls are available.

For example, a golf ball conforming to the standard that the diameter is 1.680 inches or more and the weight is 45.93 g or less may be used. If the standard is changed in the future, a golf ball conforming to the changed standard may be used to observe its contact state. Regarding the material of the surface or inside of the golf ball, the slip quantity also changes depending on the inner material or cover material of the ball, and so the 2013 PHYZ golf ball made by Bridgestone Sports Co., Ltd. is used as a standard golf ball.

To reduce the amount of backspin of the golf ball more effectively, the contact time between the golf ball and the face is preferably 0.4 msec to 0.7 msec. In the case where the contact time is 0.4 msec to 0.7 msec, the slip quantity of the golf ball can be determined more accurately, with it being possible to sufficiently reduce the amount of backspin.

The loft of the golf club head is not particularly limited, and may be any angle depending on the type of the club. To reduce the amount of backspin of the golf ball more effectively, however, the loft is preferably 20° or less, more preferably 12° or less, and further preferably 9° to 10.5°. If the loft exceeds 20°, the golf ball tends to slip, making it difficult to limit the slip quantity of the golf ball to 0.55 mm or less.

The coefficient of friction of the face and the golf ball is not particularly limited. To reduce the amount of backspin of the golf ball more effectively, however, the coefficient of friction is preferably 0.12 or more, and more preferably 0.15 to 0.30. In the case where the coefficient of friction is less than 0.12, the coefficient of friction of the face and the golf ball is too low, making it difficult to limit the slip quantity of the golf ball to 0.55 mm or less. The coefficient of friction mentioned here is the maximum static friction coefficient when a high load of 400 kgf acts between the face and the golf ball when the ball impacts with the face.

The method of measuring the slip quantity of the golf ball is not particularly limited, as long as the above-mentioned slip quantity (the distance traveled by the golf ball from when the golf ball and the face of the golf club head come into contact with each other to when the golf ball and the face of the golf club head separate from each other) can be accurately measured.

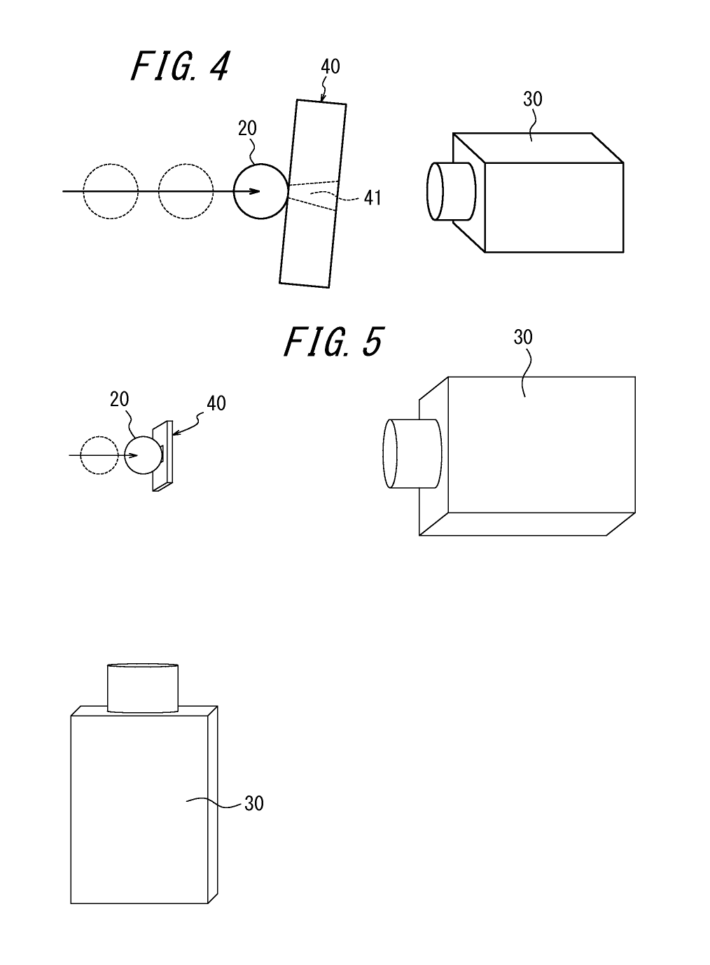

For example, the slip quantity may be measured as follows. As illustrated in FIG. 4, after the golf ball 20 is launched at the launch speed corresponding to the swing speed of the golf club, the golf ball 20 is caused to impact with a impact plate 40 made of the same material as the face of the golf club head, and the contact state between the golf ball 20 and the impact plate 40 upon the contact is observed from the front using imaging means 30 through an observation hole 41 formed in the impact plate 40.

In the case of using the impact plate 40 as illustrated in FIG. 4, the area of the observation hole 41 is preferably smaller than the contact area with the colliding golf ball 20. If the area of the observation hole 41 is increased, the influence of the observation hole 41 on the golf ball 20 increases, causing a change in spin amount or spin direction of the golf ball 20. This hampers accurate reproduction of the contact phenomenon between the golf ball and the golf club.

The contact state of the golf ball is more preferably measured from two directions, i.e. not only from the front but also from the side, as illustrated in FIG. 5. Observing the contact state of the golf ball from two directions enables more accurate measurement of the slip quantity of the golf ball.

(Golf Club)

The disclosed golf club includes the golf club head described above.

When the golf ball is hit with the golf club, the golf ball is kept from slipping on the face, so that the amount of backspin can be reduced.

(Golf Club and Golf Ball Set)

The disclosed golf club has a feature that the slip quantity of the golf ball on the face of the golf club head when the golf ball and the golf club head collide with each other is 0.55 mm or less.

When the golf ball is hit with the golf club, the golf ball is kept from slipping on the face, so that the amount of backspin can be reduced.

(Golf Club Performance Evaluation Method)

The following describes an embodiment of the disclosed golf club performance evaluation method.

The disclosed golf club performance evaluation method measures the slip quantity of the golf ball when the golf ball and the face of the golf club head collide with each other, and provides evaluation.

By measuring the slip quantity of the golf ball and evaluating it, the amount of backspin imparted on the golf ball can be determined.

The evaluation preferably includes an index of whether or not the slip quantity of the golf ball is 0.55 mm or less. Whether or not the amount of backspin is able to be reliably reduced can be evaluated based on whether or not the slip quantity of the golf ball is 0.55 mm or less.

The conditions of the golf club head and the method of measuring the slip quantity of the golf ball are the same as those described with regard to the golf club head.

### EXAMPLES

Non-limiting examples according to this disclosure are described below.

### Example 1

As illustrated in FIG. 5, a golf ball contact state observation apparatus that includes: the launching means (not illustrated) for launching the golf ball 20; the impact plate 40 with which the launched golf ball 20 impacts; and the imaging means 30 for capturing the image of the contact state between the golf ball 20 and the impact plate 40 was produced, and the contact state of the golf ball was observed.

Regarding the launching means, a tester (made by Automated Design Corporation in the U.S.) for pneumatically launching balls was used, with the rate of impingement on the impact plate 40 being 43 m/sec.

As the imaging means, a high-speed camera (made by Photron Limited) was used to observe the contact state of the golf ball. Further, the state (initial velocity, spin, hitting angle) of the golf ball 20 before and after the collision with the impact plate 40 was measured using a measuring instrument (SCIENCE EYE FIELD made by Bridgestone Sports Co., Ltd.), and analyzed using a video analyzer (TEMA made by Photron Limited) to track the trajectory of the marker of the golf ball.

As the impact plate 40, a stainless steel plate with a thickness of 10 mm was used, with the observation hole 41 being shaped as a rectangle of 20 mm in vertical width and 5 mm in horizontal width on the golf ball side. As illustrated in FIG. 4, the observation hole 41 is tapered, i.e. decreased in hole area, from the surface facing the imaging means toward the surface facing the launching means, and acrylic is fitted in the observation hole 41. The impact plate 40 was placed in a state of being tilted at 12° with respect to the vertical direction.

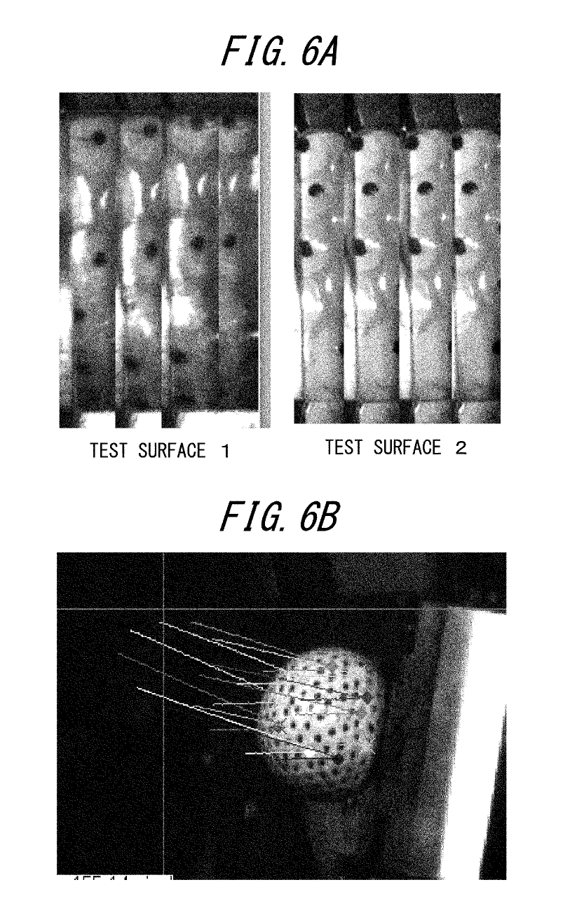

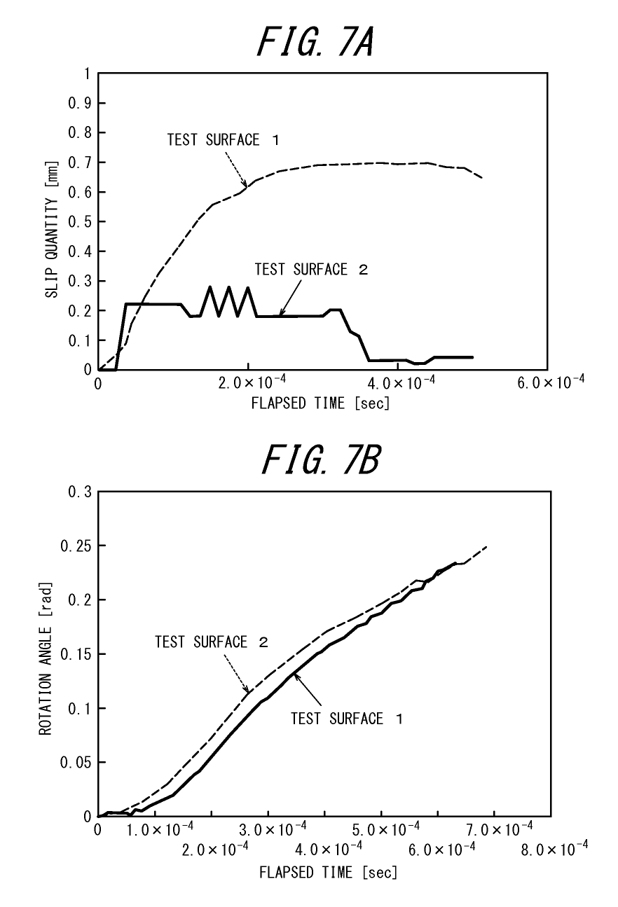

FIGS. 6A and 6B illustrate the observed contact state between the golf ball 20 and the impact plate 40 from the front and from the side, respectively. Regarding the analyzed behavior of the golf ball, FIG. 7A illustrates the temporal changes of the slip quantity (mm) of the golf ball, and FIG. 7B illustrates the temporal changes of the rotation angle (rad) of the golf ball. In FIGS. 7A and 7B, a test surface 1 is a surface roughened by sandblasting, and a test surface 2 is a surface coated with a solid lubricant. The temporal changes of the rotation angle of the golf ball cumulatively indicate, for the rotation angle (rad) of the golf ball per unit time, how much the golf ball rotated over time.

As illustrated in FIGS. 6A to 7B, the golf ball was observed to either stay on the test surface without slipping (the test surface 2) or slip on the test surface (the test surface 1) depending on the coefficient of friction of the surface (the test surface 1 and the test surface 2). As illustrated in FIG. 7B, this difference in motion affected the backspin of the golf ball.

### Example 2

In Example 2, the slip quantity (mm) and amount of backspin (rpm) of a golf ball (the 2013 PHYZ golf ball made by Bridgestone Sports Co., Ltd.) when trial-hitting the golf ball with a 1-wood (loft angle:)11.5° using a swing robot (made by Miyamae Co., Ltd.) were measured. The trial hit was performed under the conditions of three types (Ti, milling A, milling B) of the face of the club head of the 1-wood. Here, Ti denotes the face made of titanium without surface treatment. Milling A denotes the face made of titanium and subjected to laser milling under the condition of 0.5 mm in pitch, 0.1 mm in groove width, and 3 μm in groove depth. Milling B denotes the face made of titanium and subjected to laser milling under the condition of 0.5 mm in pitch, 0.2 mm in groove width, and 6 μm in groove depth.

The measured slip quantity and amount of backspin were obtained by performing the measurement under the same condition 5 times and averaging the three values except the maximum and minimum values. The measurement results are shown in Table 1.

TABLE 1

| | Slippage (mm) | Amount of backspin (rpm) |
|---|---|---|
| Ti | 0.51 | 3209 |
| Milling A | 0.35 | 3140 |
| Milling B | 0.31 | 3083 |

As can be understood from the results in Table 1, in the case of using Ti as the face, the slip quantity was large, and so the amount of backspin was largest. In the case of using the face of milling B with the smallest slip quantity, and the amount of backspin was smallest.

This demonstrates that the slip quantity of the golf ball and the amount of backspin correlate with each other, and the amount of backspin can be reduced by reducing the slip quantity.

### INDUSTRIAL APPLICABILITY

It is thus possible to provide a golf club head and a golf club that can reduce the amount of backspin of a golf ball, and a golf club performance evaluation method that can determine the amount of backspin imparted on a golf ball.

1. A golf club head having a face on which a slip quantity of a golf ball when the golf ball and the face collide with each other is 0.55 mm or less.

2. The golf club head according to claim 1,
wherein the slip quantity of the golf ball is 0.50 mm or less.

3. A golf club comprising the golf club head according to claim 1.

4. A golf club performance evaluation method comprising:
measuring a slip quantity of a golf ball when the golf ball and a face of a golf club head collide with each other, and providing an evaluation.

5. The golf club performance evaluation method according to claim 4,
wherein the evaluation includes an index of whether or not the slip quantity of the golf ball is 0.55 mm or less.

6. A golf club and golf ball set,
wherein a slip quantity of a golf ball on a face of a golf club head when the golf ball and the golf club head collide with each other is 0.55 mm or less.
